(19) United States
(12) Patent Application Publication
(10) Pub. No.: US 2015/0091210 A1
(43) Pub. Date: Apr. 2, 2015

(54) METHOD FOR FABRICATING ANISOTROPIC POLYMER PARTICLES

(71) Applicant: National Chiao Tung University, Hsinchu City (TW)

(72) Inventors: Jiun-Tai CHEN, Hsinchu City (TW); Yi-Huei KAO, Hsinchu City (TW); Mu-Huan CHI, Hsinchu City (TW)

(73) Assignee: National Chiao Tung University, Hsinchu City (TW)

(21) Appl. No.: 14/202,881

(22) Filed: Mar. 10, 2014

(30) Foreign Application Priority Data
Sep. 27, 2013 (TW) 102134967

(51) Int. Cl. B29C 43/02

(52) U.S. Cl. CPC B29C 43/021; B29K 2101/00
USPC 264/320

(57) ABSTRACT

A method for fabricating anisotropic polymer particles comprises steps: providing a first substrate; arranging a plurality of polymer spheres on the first substrate; providing a second substrate to cover the polymer spheres; heating at least one of the first substrate, the second substrate, and the polymer spheres; and applying force to the first substrate and the second substrate to squeeze the polymer spheres into a plurality of anisotropic polymer particles. The present invention uses simple compressing and heating processes to fabricate many types of anisotropic polymer structures and thus saves the cost and time of fabrication.

### BACKGROUND OF THE INVENTION

1. Field of the Invention

The present invention relates to a method for fabricating polymer particles, particularly to a method for fabricating anisotropic polymer particles.

2. Description of the Prior Art

Polymer microspheres and polymer nanoparticles are the recently emerging materials, applied to medicine vectors, biosensors, inkjet printing inks, etc. In the traditional fabrication process of electronic elements, deposition or etching is normally undertaken in high-temperature reaction environment, such as at a temperature of 200-900° C. As the glass transition temperature Tg of flexible polymer substrates normally ranges from 100 to 200° C., they cannot apply to the traditional process. However, flexible polymer substrates are very suitable to the inkjet printing process, wherein patterns are inkjet-printed on the flexible polymer substrates, and wherein polymer is an ideal material of ink. Biosensors containing biological recognition elements and signal conversion elements are used to measure physiological signals. Molecular imprinting polymers and conductive polymers have biological recognition capabilities and thus apply to biosensors. Polymer nanoparticles for medicine releasing are injected into the body to release medicine inside the body, having special shapes and allowing medicine to be dissolved therein, embedded therein or attached thereto. In the abovementioned technologies, the shape and structure of polymer microspheres or polymer nanoparticles plays a very important role. An appropriate shape of polymer microspheres or polymer nanoparticles enables signal conversion elements, medicine or other materials to stably bind to them.

In the conventional technology of fabricating anisotropic polymer particles, the particles normally need to be coated with another polymer material before they are stressed and deformed into anisotropic polymer particles. However, the conventional technology can only achieve few types of deformations. Besides, the conventional technology also needs complicated processes to prepare the substrates, such as patterning or activating the substrates.

If the method for fabricating anisotropic polymer particles has a simpler process and may achieve better deformation effect and more deformation types, the application of anisotropic polymer particles should further expand.

### SUMMARY OF THE INVENTION

One objective of the present invention is to provide a method for fabricating anisotropic polymer particles, which uses compressing and heating processes to fabricate many types of anisotropic polymer structures and thus expands the application of anisotropic polymer particles, and which has a simple process exempted from particle coating and substrate pretreatments and thus saves the cost and time of fabrication.

In one embodiment, the present invention proposes a method for fabricating anisotropic polymer particles, which comprises steps: providing a first substrate; arranging a plurality of polymer spheres on the first substrate; providing a second substrate to cover the polymer spheres; heating at least one of the first substrate, the second substrate, and the polymer spheres; and applying force to the first substrate and the second substrate to squeeze the polymer spheres into a plurality of anisotropic polymer particles.

The objective, technologies, features and advantages of the present invention will become apparent from the following description in conjunction with the accompanying drawings wherein certain embodiments of the present invention are set forth by way of illustration and example.

### BRIEF DESCRIPTION OF THE DRAWINGS

The foregoing conceptions and their accompanying advantages of this invention will become more readily appreciated after being better understood by referring to the following detailed description, in conjunction with the accompanying drawings, wherein:

FIGS. 1a-1f schematically show the steps of a method for fabricating anisotropic polymer particles according to one embodiment of the present invention.

### DESCRIPTION OF THE PREFERRED EMBODIMENT

The detailed explanation of the present invention is described as follows. The described preferred embodiments are presented for purposes of illustrations and description, and they are not intended to limit the scope of the present invention.

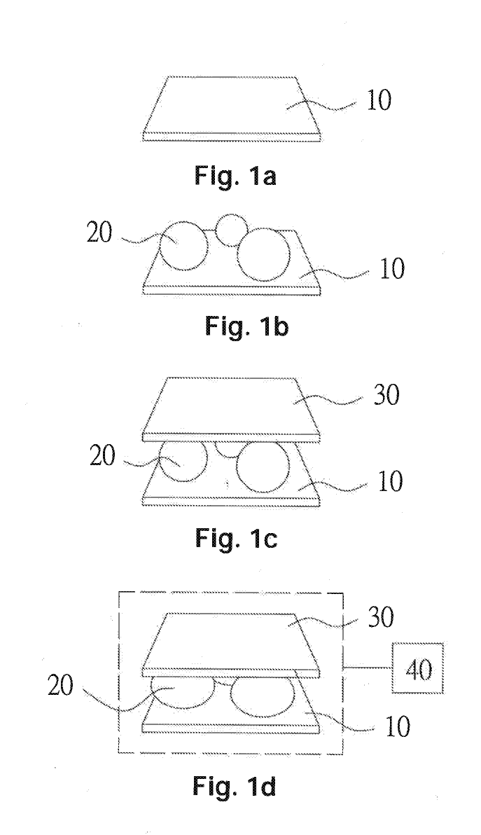

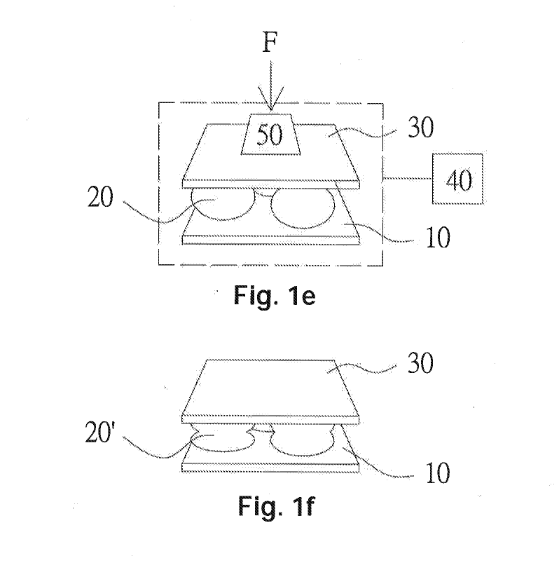

Refer to FIGS. 1a-1f diagrams schematically showing steps of a method for fabricating anisotropic polymer particles according to one embodiment of the present invention. The method of the present invention comprises steps: providing a first substrate 10 (as shown in FIG. 1a); arranging a plurality of polymer spheres 20 on the first substrate 10 (as shown in FIG. 1b); providing a second substrate 30 to cover the polymer spheres 20 (as shown in FIG. 1c); using a heating device 40 to heat the first substrate 10, the polymer spheres 20, and the second substrate 30 (as shown in FIG. 1d); applying force to the first substrate 10 and the second substrate 30 to squeeze the polymer spheres 20 (as shown in FIG. 1e) into a plurality of anisotropic polymer particles 20′ (as shown in FIG. 1f). The polymer spheres 20 are disposed on the first substrate 10 in a spin-coating method or another spreading method. The first substrate 10 is made of a plastic material or a silicon material. The polymer spheres 20 are in form of balls or ellipsoids and have a size ranging from 20 nm to 500 μm. The heating process is undertaken before or after the polymer spheres are covered by the second substrate 30.

The deformation of the polymer spheres 20 is realized via both the heating process and the compressing process. If only the compressing process is undertaken, the polymer spheres 20 may be mechanically damaged. The heating process is to modify the surface of the polymer spheres 20. It is preferred that the polymer spheres 20 are heated to about the glass transition temperature Tg of the polymer spheres 20 to make the polymer spheres 20 have plasticity. The polymer spheres 20 may be heated to a temperature near, equal to or above the glass transition temperature Tg thereof. For example, the polymer spheres 20 may be heated to a temperature of 150-200° C.

While the polymer spheres 20 is heated to a temperature near Tg, the polymer spheres 20 is modified, and the surface of the polymer spheres 20 appears sticky or wet. Thus, the polymer spheres 20 become deformable and further can wet the surface of the substrates. In one embodiment, the heating process changes the wetness of at least one of the first substrate 10, the second substrate 30 and the polymer spheres 20 and varies the surface contact interaction of the polymer spheres 20, the first substrate 10 and the second substrate 30. The wetness (hydrophilicity or hydrophobicity) will influence the surface contact interaction between the polymer spheres 20 and the substrates. Applying stress F to the wetted polymer spheres 20 will convert the polymer spheres 20 into anisotropic polymer particles 20′. The shape and structure of the anisotropic polymer particles 20′ depends on the heating temperature and the heating time, which influence the wetness, and also depends on the magnitude of the stress F. The heating process and the compressing process can be undertaken simultaneously or sequentially. In this embodiment, the method of the present invention deforms the polymer spheres 20 merely via heating and compressing, exempted from coating the polymer spheres 20 with a polymer material, complicated pretreatments of the substrates, or chemically activating the substrates. Therefore, the method of the present invention has a simple fabrication process and saves the cost and time of fabrication.

In the abovementioned embodiment, the present invention does not coat the polymer spheres 20 with another polymer material. However, coating the polymer spheres 20 with another polymer material is still an optional step of the present invention. In some embodiments, the polymer spheres 20 have a coating structure, which is an external film encapsulating an internal sphere to form the polymer sphere 20.

The shape and structure of the anisotropic polymer particles 20′ correlate with the heating temperature and the heating time, which influence the wetness of the surface of the polymer spheres 20. If stress is the dominant factor, the resultant anisotropic polymer particle 20′ has a flattened structure, like the shape of a flattened disc. If heating time is the dominant factor, the resultant anisotropic polymer particle 20′ has a columnar structure with a contracted middle region, like the shape of a dumbbell or a hourglass, as shown in FIG. 1f. If heating time has a moderate influence on deformation, the resultant anisotropic poly particle 20′ has a columnar structure with a convex middle region, like the shape of a beer barrel. The abovementioned shapes of the anisotropic particles 20′ are only for exemplification. The present invention does not limit that the anisotropic polymer particle 20′ should have one of the abovementioned shapes.

In some embodiments, a compressing device 50 or a gravity source 50 is used to apply force F to at least one of the first substrate 10 and the second substrate 30. In one embodiment, the gravity source 50 is a set of balance weights.

The polymer spheres 20 are made of at least one material selected from a group consisting of PS (polystyrene), PMMA (polymethylmethacrylate), PLA (polylactide), PCL ((polycaprolactone), PVP (polyvinylpyrrolidone), and PLGA (poly(lactic-co-glycolic acid)). In the present invention, the polymer spheres 20 are made of a single material or a mixture of different materials.

In conclusion, the present invention proposes a method for fabricating anisotropic polymer particles. The present invention uses simple compressing and heating processes to fabricate many types of anisotropic polymer structures, exempted from particle coating and substrate pretreatments. Thereby, the present invention expands the application of anisotropic polymer particles and saves the cost and time of fabrication.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit and scope of the appended claims.

What is claimed is:

1. A method for fabricating anisotropic polymer particles, comprising steps:
providing a first substrate;
arranging a plurality of polymer spheres on said first substrate;
providing a second substrate to cover said polymer spheres;
heating at least one of said first substrate, said second substrate, and said polymer spheres; and
applying force to said first substrate and said second substrate to squeeze said polymer spheres into a plurality of anisotropic polymer particles.

2. The method for fabricating anisotropic polymer particles according to claim 1, wherein said polymer spheres are in form of balls or ellipsoids.

3. The method for fabricating anisotropic poly particles according to claim 1, wherein said polymer spheres are made of at least one material. selected from a group consisting of polystyrene, polymethyl methacrylate, polylactide, polycaprolactone, polyvinylpyrrolidone, and poly lactic-co-glycolic acid.

4. The method for fabricating anisotropic polymer particles according to claim 1, wherein said polymer sphere has a coating structure, which is an external film encapsulating an internal sphere to form said polymer sphere.

5. The method for fabricating anisotropic polymer particles according to claim 1, wherein said polymer sphere is made of a single material or a mixture of different materials.

6. The method for fabricating anisotropic polymer particles according to claim 1, wherein a size of said polymer sphere ranges from 20 nm to 500 μm.

7. The method for fabricating anisotropic polymer particles according to claim 1, wherein a compressing device or a gravity source is used to apply force to at least one of said first substrate and said second substrate.

8. The method for fabricating anisotropic polymer particles according to claim 7, wherein said gravity source is a set of balance weights.

9. The method for fabricating anisotropic polymer particles according to claim 1, wherein said step of heating changes wetness of at least one of said first substrate, said second substrate and said polymer spheres, and varies surface contact interactions of said first substrate, said second substrate and said polymer spheres.

10. The method for fabricating anisotropic polymer particles according to claim 1, wherein said steps of heating and applying force are undertaken simultaneously.

11. The method for fabricating anisotropic polymer particles according to claim 1, wherein said step of heating heats said polymer spheres to a temperature near a glass transition temperature of said polymer sp and makes said polymer spheres have plasticity.

12. The method for fabricating anisotropic polymer particles according to claim 1, wherein said anisotropic polymer particle has a flattened structure, a columnar structure with a contracted middle region, or a columnar structure with a convex middle region.
